(19) United States
(12) Patent Application Publication
(10) Pub. No.: US 2020/0027365 A1
(43) Pub. Date: Jan. 23, 2020

(54) INFORMATION PROCESSING APPARATUS AND NON-TRANSITORY COMPUTER READABLE MEDIUM STORING INFORMATION PROCESSING PROGRAM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/252,680

(22) Filed: Jan. 20, 2019

(30) Foreign Application Priority Data
Jul. 20, 2018 (JP) 2018-136575

(51) Int. Cl. G09B 7/04

(52) U.S. Cl. CPC G09B 7/04

(57) ABSTRACT

An information processing apparatus includes a notification unit that notifies each user who uses target data of information indicating suitability of the target data for purpose of use of the user.

### CROSS-REFERENCE TO RELATED APPLICATIONS

This application is based on and claims priority under 35 USC 119 from Japanese Patent Application No. 2018-136575 filed Jul. 20, 2018.

### BACKGROUND

### (i) Technical Field

The present invention relates to an information processing apparatus and a non-transitory computer readable medium storing an information processing program.

### (ii) Related Art

In the related art, an education system that delivers a content for learning to a user terminal used by a user through the Internet has been known (for example, JP2011-191327A, JP2001-256314A, JP2007-271642A, and JP2003-295747A).

### SUMMARY

However, in a case where the user selects various target data items, it is difficult to determine whether or not the selected target data is target data suitable for an attribute of the user or purpose of use of the user in some cases. For example, it is difficult for a teacher or a learner as the user to select a suitable question according to the attribute (for example, whether the user is the teacher or the learner) of the user and the purpose of use (for example, whether the question is for measuring ability of the learner or for improving the ability of the learner) of the user among various questions as the target data in some cases.

Aspects of non-limiting embodiments of the present disclosure relate to a technology that supports a user to select target data suitable for the purpose of use of the user.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a notification unit that notifies each user who uses target data of information indicating suitability of the target data for purpose of use of the user.

### BRIEF DESCRIPTION OF THE DRAWINGS

Exemplary embodiment(s) of the present invention will be described in detail based on the following figures, wherein:

FIG. 1 is a schematic configuration diagram of an information processing apparatus according to the present exemplary embodiment;

FIG. 2 is a diagram showing an example of contents of a user DB;

FIG. 3 is a diagram showing a first example of contents of a question DB;

FIG. 4 is a diagram showing a second example of the contents of the question DB;

FIG. 5 is a diagram showing a third example of the contents of the question DB; and

FIG. 6 is a conceptual diagram showing a case where suitable target data is selected by a text.

### DETAILED DESCRIPTION

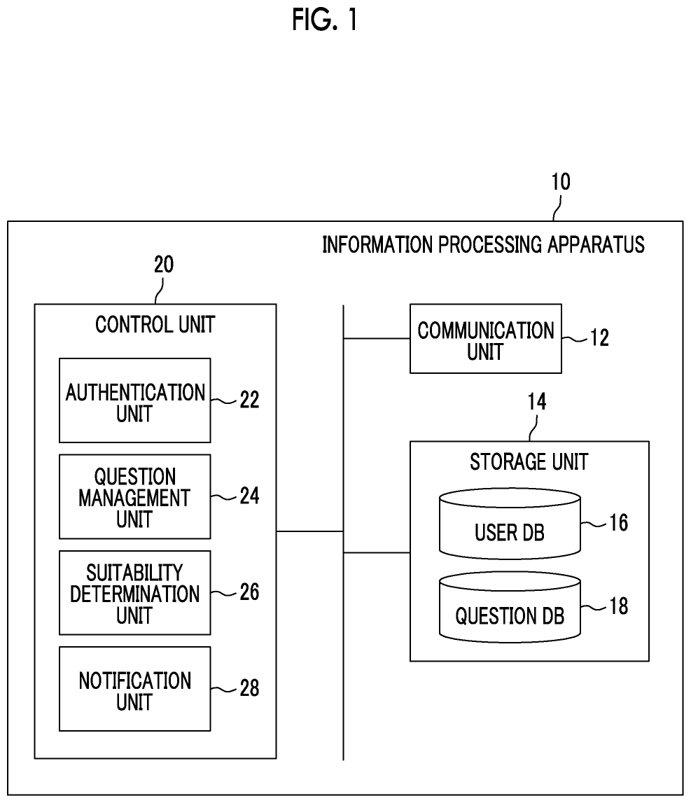

FIG. 1 is a schematic configuration diagram of an information processing apparatus 10 according to the present exemplary embodiment. In the present exemplary embodiment, the information processing apparatus 10 is a server, and the information processing apparatus 10 may be, for example, another apparatus such as a personal computer or a mobile terminal such as a tablet as long as the apparatus can realize the following functions.

In the present exemplary embodiment, the information processing apparatus 10 manages questions as target data, and provides a service (hereinafter, described as a “question management service”) which provides the questions to a user. In this example, the question is a concept which encompasses a test question (test) and an exercise question. The test is to measure a learner's ability, and has a content capable of measuring the learner's ability. The content of the test is not known to the learner who solves the test question. Meanwhile, the exercise question is to improve the learner's ability, and the content of the test may be known to the learner who solves the exercise question (may not be known to the learner, of course).

A communication unit 12 includes, for example, a network adapter. The communication unit 12 has a function of communicating with another apparatus (for example, a user terminal used by a user) through a communication line such as a LAN or the Internet. The user terminal may be a personal computer or a mobile terminal such as a tablet. Particularly, the communication unit 12 receives an access request from the user terminal, and transmits information corresponding to the access request to the user terminal.

In a case where the information processing apparatus 10 is a personal computer or a mobile terminal, the information processing apparatus may include an input unit which includes, for example, a touch panel, a keyboard, a voice input, or a mouse for inputting the access request from the user, and a display unit which includes, for example, a liquid crystal panel for displaying the information corresponding to the access request from the user.

A storage unit 14 includes, for example, a ROM, a RAM, or a hard disk. An information processing program for operating the units of the information processing apparatus 10 is stored in the storage unit 14. As shown in FIG. 1, a user DB 16 and a question DB 18 are defined in the storage unit 14.

Information regarding the user who receives the question management service provided by the information processing apparatus 10 is stored in the user DB 16. The user performs user registration for the service at the time of starting to use the question management service. The information input at the time of the user registration is stored in the user DB 16.

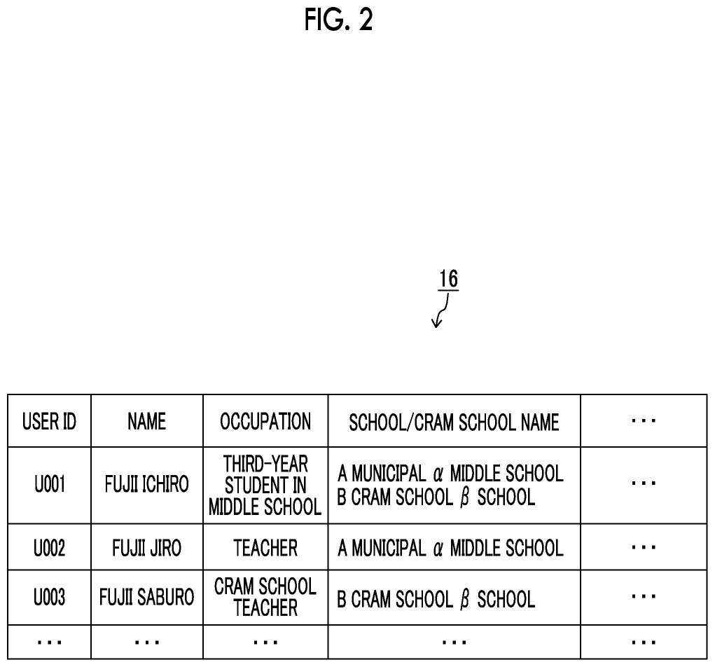

FIG. 2 shows an example of contents of the user DB 16. As shown in FIG. 2, a user ID which is an identifier for uniquely identifying the user and user attribute information as user attribute information indicating an attribute of the user are associated with each other in the user DB 16. Although the user DB 16 is represented in a table format and one record corresponds to one user in FIG. 2, a structure of the user DB 16 is not limited thereto.

FIG. 2 shows a name, an occupation, and a school/cram school name of the user, as the user attribute information. The occupation is, for example, a student, a teacher, and a cram school teacher. In a case where the occupation is the student, the occupation may include information indicating a grade, for example. The school/cram school name is a school of the user in a case where the user is the student, and is a working place of the user in a case where the user is the teacher or the cram school teacher. That is, the school/cram school name indicate the whereabouts of the user. The school/cram school name may include, for example, information (for example, “A municipal”) for knowing a location of the school/cram school. The user attribute information is not limited to the information shown in FIG. 2, and may include, for example, information indicating background, best subject and qualifications of the user.

The question managed by the question management service (that is, the information processing apparatus 10) and information regarding the question are stored in the question DB 18. The question is created by a question creator. The question is uploaded to the information processing apparatus 10 from a terminal used by the question creator and is stored in the question DB 18.

In the present exemplary embodiment, active learning type questions are stored in the question DB 18. The active learning is different from a knowledge-based learning method of the related art, and is a general term of a learning method in which the learner actively learns. The active learning is a learning method expected to improve a thinking power, a logical thinking power, or activeness of the learner. In a case where mathematics is used as an example, a knowledge-based question is, for example, a quadratic function calculation question. For example, the active learning type question is a question about “extract which city is statistically easy to live, and explain the reason”. A correct answer is uniquely determined for the knowledge-based question in many cases, but the active learning type question is not necessarily one correct answer.

The active learning type question and the knowledge-based question may be registered in a mixed state in the question DB 18.

The question creator may create a correct answer or a hint of the question together with the question, and may store the correct answer or hint of the question in association with the question in the question DB 18. As stated above, since a plurality of correct answers is considered for the active learning type question, a plurality of correct answers for one question may be registered in the question DB 18. Even in the case of the knowledge-based question, a plurality of correct answers is registered for one question in some cases. For example, a trend of the correct answer is different depending on the cram school, and the cram schools upload the correct answers for the same question to the information processing apparatus 10 in some cases.

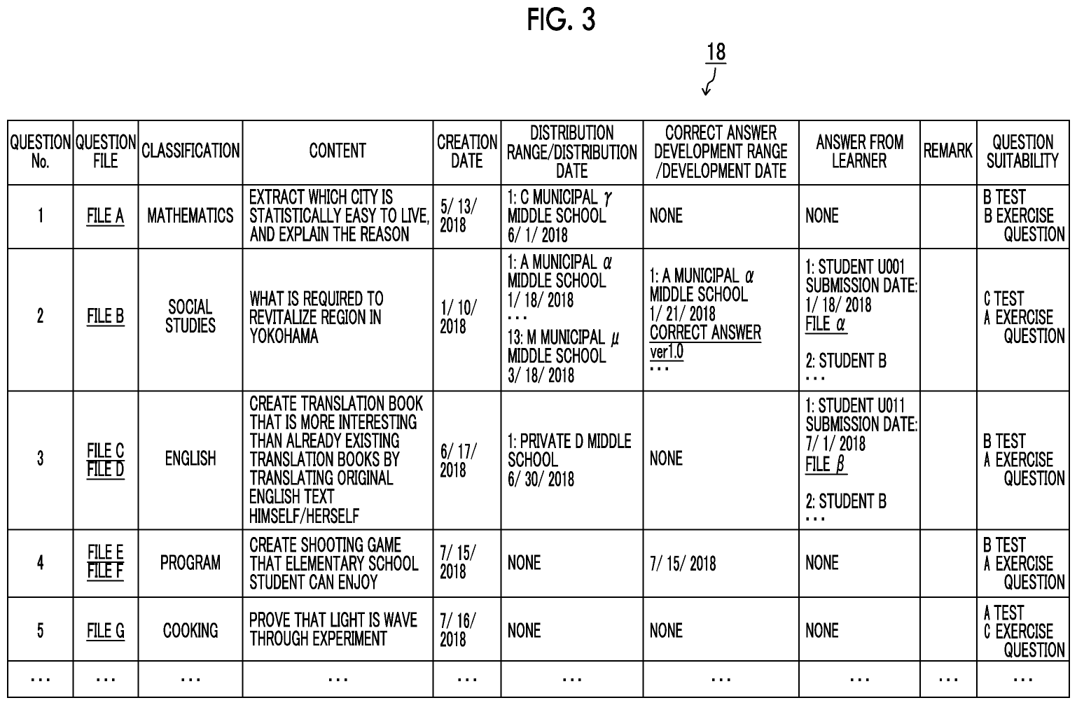

FIG. 3 shows an example of contents of the question DB 18. As shown in FIG. 3, a question No. which is an identifier for uniquely identifying the question, a question file (an electronic file of the question), question attribute information as data attribute information indicating an attribute of the question, and question suitability are stored in association with each other in the question DB 18. The question DB 18 of FIG. 3 is also represented in a table format, but a structure of the question DB 18 is not limited thereto.

FIG. 3 shows a plurality of items such as a classification, content, creation date, and distribution range/distribution date of the question, and a correct answer development range/development date of the question, an answer from the learner, and a remark, as the question attribute information. The classification indicates the kind (or may be referred to as a subject) of the question, and is, for example, mathematics, social studies, and programs. The creation date is a date when the question creator creates the question or a date when the question is uploaded to the information processing apparatus 10. In addition to the date, a time may be recorded as the creation date. In a case where the question file is stored in the question DB, the classification, content, and creation date of the question among the question attribute information items are registered by a question management unit 24 to be described below.

The distribution range/distribution date indicates a range and a date in which the question file registered in the question DB is distributed. For example, as shown in FIG. 3, in a case where a question of which a question No. is “2” is distributed to a student who goes to “A municipal α middle school”, “A municipal α middle school” is registered as the distribution range. The distribution range is not limited to the unit of school. For example, the distribution range may be a slightly wide range such as “A municipal”, or may be a slightly narrow range such as “third-year student in A municipal α middle school”. Of course, the distributed date (or which may include the time) is registered as the distribution date.

The correct answer development range/development date indicate a range and a date in which the correct answer corresponding to the distributed question is developed. For example, in a case where a correct answer for the question of which the question No. is “2” is distributed to the student who goes to “A municipal α middle school”, “A municipal α middle school” is registered as the correct answer development range. Similarly to the distribution range, the correct answer development range is not limited to the unit of school. Of course, the distributed date (or which may include the time) is registered as the development date.

In the present exemplary embodiment, the correct answer development range and development date are registered in the question DB 18. However, in a case where the hint of the question is registered in the question DB 18, a development range and a development date of the hint may be registered in the question DB 18. In a case where the plurality of correct answers is registered for one question, information for identifying the developed correct answer may be registered. For example, in the example of FIG. 3, a developed correct answer file name is described as “correct answer ver1.0” in the field of the correct answer development range/development date of the question of which the question No. is “2”, and the correct answer can be identified by version information.

The answer from the learner indicates whether or not the answer of the learner for the distributed question is received. “NONE” is registered in a case where the answer from the learner is not received, and an uploaded answer file, a user ID of the learner who uploads the answer, and an uploaded date and time are registered as the answer from the learner in a case where the answer from the learner is uploaded to the question management service.

In a case where the question or the correct answer registered in the question DB 18 are transmitted to the user terminal or in a case where the answer file is received from the user terminal, the distribution range/distribution date, the correct answer development range/development date, and the answer from the learner among the question attribute information items are registered by the question management unit 24 to be described below.

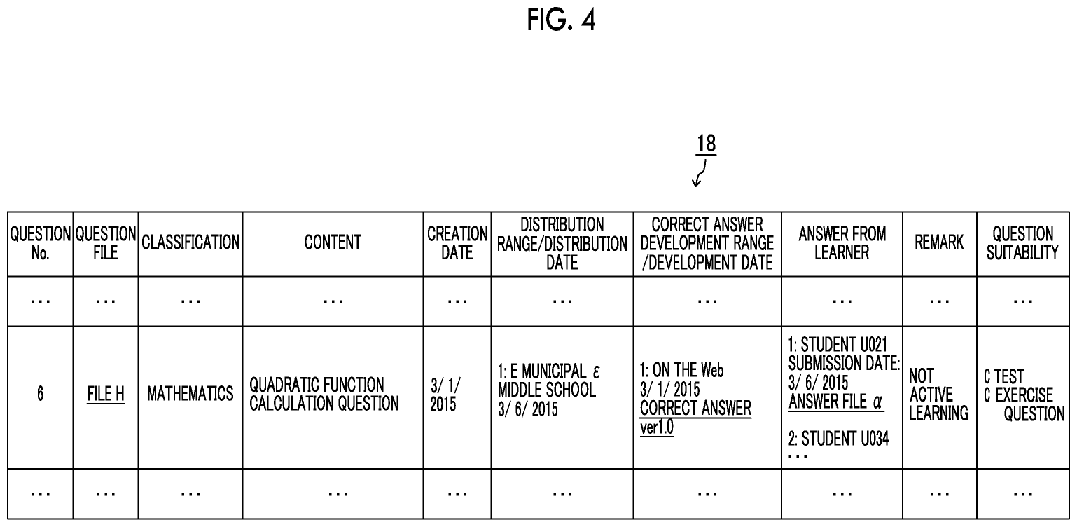

The remark is reference information regarding the question. In the present exemplary embodiment, as shown in FIG. 4, in a case where the knowledge-based question is registered in the question DB 18, a remark such as “not active learning type” is attached as the remark of the question. The remark is not limited thereto, and various information items regarding the question can be attached.

The question suitability indicates suitability of the question. In the present exemplary embodiment, the question suitability indicates whether or not the question registered in the question DB 18 is suitable for the user in a case where the purpose of use is used as the test and whether or not this question is suitable for the user in a case where the purpose of use is used as the exercise question. The question suitability is determined and registered by a suitability determination unit 26 to be described below. The details of the question suitability will be described below.

In the present exemplary embodiment, the user DB 16 and the question DB 18 are stored in the information processing apparatus 10. These information items may be stored in another apparatus as long as the information processing apparatus 10 can access these information items.

A control unit 20 includes, for example, a CPU or a microcontroller. The control unit 20 controls the units of the information processing apparatus 10 according to the information processing program stored in the storage unit 14. As shown in FIG. 1, the control unit 20 also functions as an authentication unit 22, the question management unit 24, the suitability determination unit 26, and a notification unit 28.

The authentication unit 22 authenticates the user who accesses the question management service. For example, the authentication unit 22 may authenticate the user by requesting that the user inputs a user ID and a password, and the authentication method is not limited thereto. The authentication unit 22 performs a user registration process in the question management service.

According to the request of the user who accesses the question management service, the question management unit 24 transmits the question, the correct answer, or the hint registered in the question DB 18 to the user terminal used by the user, and registers the question attribute information to be changed by the transmission process in the question DB 18. Alternatively, the question management unit registers the question, the correct answer, and the hint which are transmitted by the user, or the answer from the learner in the question DB 18, and registers the question attribute information regarding the question in the question DB 18.

The question management unit 24 may count a time from a timing when the question is transmitted to the user terminal used by the user, transmit the hint to the user terminal after a predetermined time elapses from when the question is transmitted to the user, and transmit the correct answer to the user terminal after a predetermined time further elapses.

The question management unit 24 may not transmit (may restrict the access to) the question to another user terminal for a predetermined time after the question is transmitted to the user terminal used by the user. Accordingly, it is possible to maintain the openness of the question low, and it is possible to maintain the suitability of the question as the test, as will be described in detail below.

The suitability determination unit 26 determines whether or not the question is suitable for the purpose of use of the user authenticated by the authentication unit 22 (hereinafter, simply referred to as the “suitability of the question” in some cases). In the present exemplary embodiment, the purpose of use is the purpose as the test and the purpose as the exercise question. That is, in the present exemplary embodiment, the suitability determination unit 26 determines whether or not the question stored in the question DB 18 is suitable for the authenticated user in a case where this question is used as the test and whether or not this question is suitable for this user in a case where this question is used as the exercise question.

In the present exemplary embodiment, the suitability determination unit 26 determines the suitability of the question based on the question attribute information registered in the question DB 18. Specifically, the suitability determination unit 26 calculates a degree of openness for the user for each question based on the user attribute information of the authenticated user and the question attribute information of each question.

The suitability determination unit 26 determines that the question is more suitable as the test as the calculated degree of openness becomes lower, and determines that the question is not suitable as the exercise question. As stated above, this is because the content of the test is not to be known to the learner and there is a concern that the question loses suitability as the test due to a rise in degree of openness (as will be described in detail below) in a case where the question having a low degree of openness is used as the exercise question. Meanwhile, the suitability determination unit 26 determines that the question is not suitable as the test as the calculated degree of openness becomes higher, and determines that the question is more suitable as the exercise question. Alternatively, the suitability determination unit 26 may determine that the question is “suitable” in a case where the degree of openness is equal to or greater than a first threshold value, and may determine that the question is “not suitable” in a case where the degree of openness is equal to or less than the first threshold value or is equal to or less than a second threshold value smaller than the first threshold value.

As will be described in detail below, since the degree of openness is calculated with consideration for the user attribute information, the degree of openness is different for each user for even the same question in some cases. Accordingly, the suitability of the question is different for each user for even the same question in some cases.

There are various methods as the calculation method of the degree of openness based on the user attribute information and the question attribute information. For example, the degree of openness is calculated as follows.

Initially, the degree of openness can be calculated depending on whether or not the question is distributed (opened). Specifically, the degree of openness of the question increases in a case where the question is distributed, and the degree of openness of the question decreases in a case where the question is not distributed.

The degree of openness can be calculated based on a time from a point of time of distributing the question to a current point of time. Specifically, as the time from the point of time of the question distribution to the current point of time becomes longer, the degree of openness of the question may decrease. In this regard, the degree of openness may be calculated by different methods in the active learning type question and the knowledge-based question. That is, the correct answer is not changed very much for the knowledge-based question even though the time elapses from the point of time of the distribution, whereas the correct answer is changed for the active learning type question even though the time elapses from the point of time of the distribution in some cases. For example, the correct answer may be changed for the question about “extract which city is statistically easy to live, and explain the reason” like the question of the mathematics shown in FIG. 3 depending on an environment of each city at a point of time when the question is solved. Accordingly, the degree of openness of the active learning type question may further decrease than the degree of openness of the knowledge-based question even though the time from the point of time of the question distribution to the current point of time is equal in these questions. Incidentally, the suitability determination unit 26 can further grasp whether the question is the knowledge-based question or the active learning type by the remark field of the question DB 18.

The degree of openness can be calculated depending on the distribution range of the question. Specifically, the degree of openness of the question in a case where the distribution range of the question further increases than the degree of openness in a case where the distribution range of the question is narrow. For example, the degree of openness of the question does not increase very much in a case where the question is distributed to the restricted region (A municipal α middle school), whereas the degree of openness of the question may considerably increase in a case where the question is opened on the Web.

The degree of openness of the question for the user may be calculated in the relationship between the distribution range of the question and the whereabouts (the school, cram school, or working place) of the user. For example, in a case where the question is distributed to the restricted region (for example, A municipal α middle school), the degree of openness of the question for the user (for example, the student in the A municipal α middle school) of which the whereabouts is this region may considerably increase, whereas the degree of openness of the question for the user of which the whereabouts is another region may not be changed as compared with the user of which the whereabouts is this region.

Similarly to whether or not the question is distributed, the degree of openness can also be calculated depending on whether or not the correct answer or the hint of the question is distributed. Similarly to the distribution range of the question, the degree of openness can also be calculated depending on the distribution range of the correct answer or the hint of the question. In this regard, the degree of openness may be calculated by different methods in the active learning type question and the knowledge-based question. That is, there is one or a few correct answer for the knowledge-based question in some cases, whereas a plurality of correct answers for the active learning type question in some cases. Accordingly, in a case where one correct answer is distributed, the degree of openness of the knowledge-based question may further increase than the degree of openness of the active learning type question.

The degree of openness can be calculated depending on whether or not the answer of the learner is received. Specifically, the degree of openness of the question increases in a case where the answer from the learner is uploaded to the question management service, and the degree of openness of the question decreases in a case where the answer from the learner is not uploaded to the question management service. In this regard, the degree of openness may be calculated by different methods in the active learning type question and the knowledge-based question as stated above.

The degree of openness may be calculated in consideration with the user attribute information of the learner who uploads the answer. For example, as the whereabouts of the learner who uploads the answer and the whereabouts of the user who is currently authenticated become closer to each other, the degree of openness of the question corresponding to the answer for the user may increase. Of course, in a case where the learner who uploads the answer and the user who is currently authenticated are the same person, the degree of openness of the question corresponding to the answer for the user considerably increases.

As stated above, the suitability determination unit 26 determines whether or not the question stored in the question DB 18 is suitable for the authenticated user in a case where this question is used as the test and whether or not this question is suitable for the authenticated user in a case where this question is used as the exercise question, and registers the determination results in the question DB 18. FIG. 3 or 4 shows the suitability of each question registered in the question DB 18 as the test and the suitability of each question as the exercise question. The suitability may be not only two-stage evaluation in which the question is suitable (“A”) and the question is not suitable (“C”) but also multi-stage evaluation in which the question is suitable, the question is not suitable, and the question is somewhat suitable (“B”) as an intermediate state thereof.

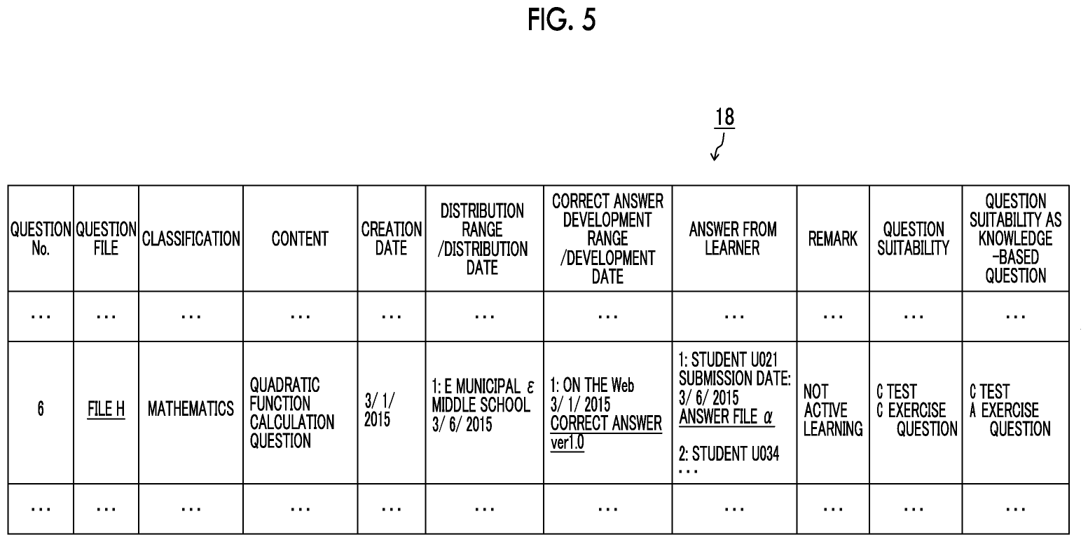

AS shown in FIG. 5, the suitability determination unit 26 may separately determine the question suitability as the active learning type question and the question suitability as the knowledge-based question, and may register the determination results in the question DB 18. Basically, the suitability determination unit 26 determines the question suitability as the active learning type question for the active learning type question through the aforementioned process, and determines that the question is suitable as neither the test nor the exercise question for the question suitability as the active learning type question. The suitability determination unit 26 determines the question suitability as the knowledge-based question for the knowledge-based question through the aforementioned process, and determines that the question is not suitable as the test but is suitable as the exercise question for the question suitability as the knowledge-based question.

The notification unit 28 notifies the user of the suitability of the question regarding the purpose of use of the authentication user which is determined by the suitability determination unit 26. In the present exemplary embodiment, the notification unit 28 displays the table including the question suitability for the user for each question registered in the question DB 18 on a display unit of the user terminal as shown in FIG. 3. Accordingly, the user may grasp the question suitability for each question registered in the question DB 18 (that is, whether each question is suitable for the test or the exercise question for the user).

In the present exemplary embodiment, since the notification unit 28 notifies the user of the information registered in the question DB 18, the notification unit also notifies the user of the question attribute information of the question registered in the question DB 18. Accordingly, the user may grasp the attribute of the question, for example, the classification or content of the question, in addition to the question suitability.

In a case where the question attribute information includes the plurality of items as shown in FIG. 3, the notification unit 28 may select the item to be notified to the user according to the user attribute information of the authenticated user. For example, the notification unit 28 may notify (open to the public) only a teacher in the same A municipal α middle school as the student of the answer file uploaded to the question management service by the student in the A municipal α middle school. Alternatively, the notification unit 28 may notify only an educator such as the teacher or the cram school teacher of the correct answer file, and may not notify the learner of the correct answer file. However, in a case where it is apparent that even the learner voluntarily takes and scores the test at the time of logging in, the notification unit 28 may notify the learner of the correct answer file.

Generally, it is difficult to solve the active learning type question in a case where the learner has no prerequisite peripheral knowledge. Accordingly, the notification unit 28 may notify only the user who solves the knowledge-based question and satisfies a predetermined condition (for example, gets points equal to or greater than a threshold point) regarding the answer of the active learning type question related to the knowledge-based question or the question suitability thereof.

The notification method of the question suitability using the notification unit 28 is not limited thereto. For example, the user may designate the question registered in the question DB 18, and the notification unit 28 may notify the user of the question suitability regarding the designated question or the question attribute information.

An aspect in which the user designates the condition including the purpose of user and the notification unit 28 searches for the question suitable for the condition from the question DB 18 and notifies the user of the searched question can also be adopted. In such an aspect, the user can input the condition including the purpose of use to the question management service as an inquiry sentence. In this case, the notification unit 28 notifies of the question suitable for the purpose of use of the user based on an analysis result of the inquiry sentence input by the user.

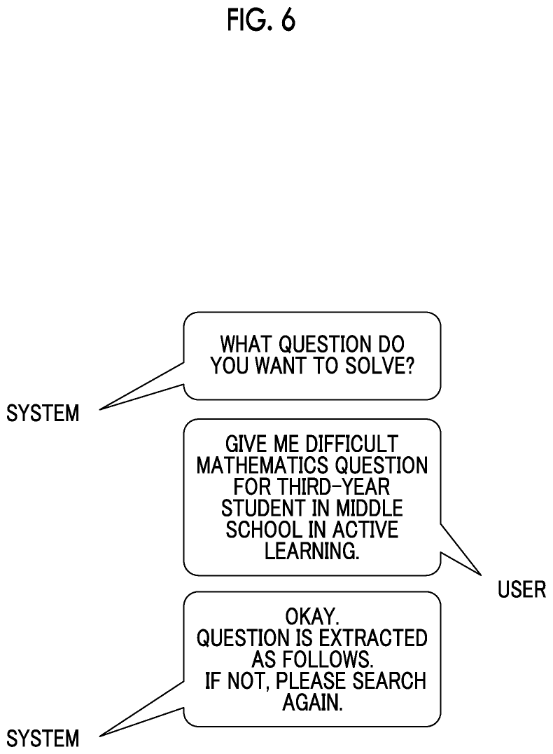

The inquiry sentence may be a character string input to the user terminal by the user. For example, as shown in FIG. 6, the question management service can provide a text chat form to the user, and the user can input the inquiry sentence through the text chat. The user may input the inquiry sentence with voice.

The schematic configuration diagram of the information processing apparatus 10 according to the present exemplary embodiment is as described above. According to the present exemplary embodiment, the information indicating the suitability of the question for the purpose of use of the user is notified to the user. Accordingly, the user may select the suitable question corresponding to the purpose of use of the user.

While the exemplary embodiments according to the present invention have been described, the present invention is not limited to the exemplary embodiments. The exemplary embodiments can be modified in various manners without departing from the gist of the present invention.

As an example of a modification example, although it has been described in the exemplary embodiment that the information processing apparatus 10 manages the question as the target data and the notification unit 28 notifies the suitability of the question for the purpose of use of the user, the target data of the present invention is not limited to the question.

For example, the information processing apparatus 10 may manage, as the target data, software such as an application or a game, and a software DB instead of or in addition to the question DB 18 may be defined in the storage unit 14.

An age of the user is registered in the user DB 16, and a content of the software is registered in the software DB. Thus, the suitability determination unit 26 can determine suitability of the software for education and suitability of the software for entertainment, as the suitability of the purpose of use, based on the age of the user and the content of the software.

For example, in a case where the user is 5 years old, the suitability determination unit 26 can determine that a game suitable for education for 5-year old children is suitable for the education. In a case where the user is 10 years old, the suitability determination unit 26 can determine that the game suitable for the education for 5-year old children is not suitable for the education but is suitable for the entertainment.

The notification unit 28 can notify of the suitability regarding the purpose of use of the software (whether the software is for the education or for entertainment) for the user.

Of course, the example of the software is an example, and the present invention is applicable to various target data items.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a notification unit that notifies each user who uses target data of information indicating suitability of the target data for purpose of use of the user.

2. The information processing apparatus according to claim 1,
wherein the notification unit notifies the suitability of the target data corresponding to user attribute information of the user.

3. The information processing apparatus according to claim 2, further comprising:
a suitability determination unit that determines the suitability of the target data for the purpose of use of the user based on data attribute information regarding the target data.

4. The information processing apparatus according to claim 3,
wherein the notification unit notifies the user of the data attribute information.

5. The information processing apparatus according to claim 4,
wherein the data attribute information includes a plurality of items, and
the notification unit selects the item to be notified to the user according to the user attribute information.

6. The information processing apparatus according to claim 3,
wherein the target data is a question that includes a test for measuring ability of a learner and an exercise question for improving the ability of the learner.

7. The information processing apparatus according to claim 6,
wherein the question includes an active learning type question.

8. The information processing apparatus according to claim 7,
wherein the suitability determination unit determines that the question is suitable for the test as a degree of openness of the question based on the user attribute information and the data attribute information becomes lower, and determines that the question is suitable for the exercise question as the degree of openness of the question becomes higher.

9. The information processing apparatus according to claim 8,
wherein the suitability determination unit decreases the degree of openness of the question as a time from a point of time of distribution of the question to a current point of time becomes longer.

10. The information processing apparatus according to claim 7,
wherein the question further includes a knowledge-based question, and
the notification unit notifies of the active learning type question in a case where a predetermined condition regarding an answer of the user for the knowledge-based question is satisfied.

11. The information processing apparatus according to claim 6,
wherein the notification unit notifies of at least one of a correct answer or a hint regarding the question after a predetermined time elapses from when the question is transmitted to the user.

12. The information processing apparatus according to claim 7,
wherein the notification unit notifies of at least one of a correct answer or a hint regarding the question after a predetermined time elapses from when the question is transmitted to the user.

13. The information processing apparatus according to claim 8,
wherein the notification unit notifies of at least one of a correct answer or a hint regarding the question after a predetermined time elapses from when the question is transmitted to the user.

14. The information processing apparatus according to claim 9,
wherein the notification unit notifies of at least one of a correct answer or a hint regarding the question after a predetermined time elapses from when the question is transmitted to the user.

15. The information processing apparatus according to claim 10,
wherein the notification unit notifies of at least one of a correct answer or a hint regarding the question after a predetermined time elapses from when the question is transmitted to the user.

16. The information processing apparatus according to claim 1,
wherein the notification unit notifies of the target data suitable for the user based on an analysis result of an inquiry sentence input by the user.

17. The information processing apparatus according to claim 2,
wherein the notification unit notifies of the target data suitable for the user based on an analysis result of an inquiry sentence input by the user.

18. The information processing apparatus according to claim 3,
wherein the notification unit notifies of the target data suitable for the user based on an analysis result of an inquiry sentence input by the user.

19. The information processing apparatus according to claim 4,
wherein the notification unit notifies of the target data suitable for the user based on an analysis result of an inquiry sentence input by the user.

20. A non-transitory computer readable medium storing an information processing program causing a computer to function as:
a notification unit that notifies each user who uses target data of information indicating suitability of the target data for purpose of use of the user.
